(19) United States
(12) Patent Application Publication
(10) Pub. No.: US 2020/0111385 A1
(43) Pub. Date: Apr. 9, 2020

(54) TRAINING PROGRAM FOR ASSESSMENT AND IMPROVEMENT OF INTERACTION WITH VIDEO GAME INTERFACES

(71) Applicant: Gamers Net, Inc., Santa Monica, CA (US)

(72) Inventors: Amine Issa, Marina Del Ray, CA (US); Maximilian Benito Schallwig, Munich (DE); Hewitt Brume Benson, Marina Del Ray, CA (US)

(21) Appl. No.: 16/153,605

(22) Filed: Oct. 5, 2018

(51) Int. Cl. G09B 19/00; G09B 5/02

(52) U.S. Cl. CPC G09B 19/0053; A63F 13/20; G09B 5/02

(57) ABSTRACT

Interactive interfaces provide an environment to a user suitable for simultaneously assessing and/or training skills of the user corresponding to different types of cognitive and motor skills utilized in performing certain tasks or operating other types of software programs (e.g., a competitive video game). The interface displays different elements to the user within multiple display areas that prompt the user to perform different types of actions over overlapping time periods, allowing for different types of skills such as the user's mechanical skills, executive function, background processing, and situational awareness ability to be assessed and trained. In addition, the simultaneous assessment/training of multiple skills through simultaneous prompting of different input or action types allows for additional skills, e.g., multitasking ability, to be assessed or trained, where such assessment/training would not be possible if the user was only prompted to perform one type of input or action during a time period.

### BACKGROUND

The present disclosure generally relates to software training and assessment tools, and specifically to interfaces for training and assessing user skills that are useful for operation of video games and user interfaces of other software programs.

Video gaming and e-sports are increasingly popular in today's world. For example, multiplayer online battle arena (MOBA) games such as League of Legends (LoL) and Defense of the Ancients 2 (DotA2) boast player bases having millions of active users, and vibrant professional scenes rivalling those of many conventional sports. To be competitive, players of these games must possess certain combinations of skills that they develop and train. In addition, players having different skills may be able to perform better in different roles on a team. By assessing the strengths of each player, players can be organized on a team that best utilizes their individual abilities.

### SUMMARY

Interactive interfaces may be used to provide an audio-visual environment to a user suitable for simultaneously assessing and/or training in a plurality of different skills of the user. These skills may correspond to different types of cognitive and motor skills that are utilized by the user in performing certain tasks or operating other types of software programs (e.g., a competitive video game). Combining performance in this task with carefully analyzed interaction data associated with the task creates a solid foundation for assessing player performance and detailing training and improvement protocols. By creating an environment in which the user is prompted to perform different types of actions requiring various levels of motor and cognitive ability, the skills of the user in these different areas may be trained and improved.

In some embodiments, an interactive game interface is provided to a user at a user device. The interface is configured to display different elements to the user within multiple display areas that prompt the user to perform different types of actions or inputs. For example, the interface may, within a first display area, present to the user a first set of prompts over a time period prompting the user to perform a first type of input, and, within a second display area, present to the user a second set of prompts over the time period prompting the user to perform a second type of input. In some embodiments, the interface may be configured such that the first type of input requires a high level of mechanical skill (e.g., corresponding to hand eye coordination, reaction time, and/or fine motor skills), while performance of the second type of input only a lower level of mechanical skill (but which may require a higher level of executive function involving decision making, object detection/tracking, multitasking, and background processing). As the user is prompted at different areas of the interface to perform different types of inputs over overlapping time periods, the user is induced to exercise their motor skills to successfully perform the first type of input in response to the displayed elements, while maintaining sufficient attention of the second display area in order to successful perform the second type of input. The overlapping time periods will test the user's ability to correctly allocate the correct amounts of mental resources and attention to each task, such that they can succeed at multiple tasks. These tasks may require different areas of cognitive function to be managed, so that the internal mental processing and external physical commands are coherent. As such, different types of skills such as, but not limited to, the user's mechanical skills, object valuation, game knowledge, and situational awareness ability can be assessed and trained. In addition, the simultaneous assessment/training of multiple skills through simultaneous prompting of different input or action types allows for certain complimentary skills, such as the user's multitasking ability, to be assessed or trained, where such assessment/training would not be possible if the user was only prompted to perform one type of input or action during a time period. In addition, individual training of each of these skills is not as effective as it does not accurately reflect the real game.

The interface receives, from the user during the time period, a first set of the first type of input in response to the first set of prompts, and a second set of the second type of input in response to the second set of prompts, allowing for a skill level of the user to be assessed over the course of a session. In some embodiments, skill levels of the user may be assessed by generating a first performance metric based upon position and timing of the received first set of inputs relative to the displayed first set of prompts, indicating a level of proficiency of the user in a first skill, and a second performance metric based upon a timing of the received second set of inputs relative to the displayed second set of prompts, indicating a level of proficiency of the user in a second skill. These multiple sets of inputs are subject to a degree of randomness to optimally test player abilities to adapt in the moment. In addition, an additional performance may be generated based upon a level of disparity between the individually assessed performance metrics (e.g., the first performance metric and the second performance metric), indicating an ability of the user to multitask. These joint results over multiple sessions can be used to get an understanding of a user's executive functions, especially when the difficulty level is appropriately set to challenge the user over the array of the skills being assessed. The plurality of performance metrics may be used to update a profile of the user, and to configure future training sessions for the user. The user profile can be used to identify strengths and weaknesses of the user in different skill areas, which is usable for placement of the user on a team that best takes advantages of their skills, identify skills of the user to emphasize in training, and/or the like.

### BRIEF DESCRIPTION OF THE DRAWINGS

FIG. 1 illustrates a system for player training and assessment, in accordance with some embodiments.

FIG. 2A illustrates an example of a generated game interface that may be used to assess and train user skills, in accordance with some embodiments.

FIG. 2B illustrates another example of a generated game interface that may be used to assess and train user skills, in accordance with some embodiments.

FIG. 3 illustrates an example metrics page, in accordance with some embodiments.

FIG. 4 is a flowchart of a process for assessing user skill levels using a game interface, in accordance with some embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Competitive videogames and e-sports are rising in popularity and profitability in today's world. To be successful, recreationally or professionally, players of competitive videogames may need to possess a variety of different skills. For example, many games require a player to be able to quickly and accurately perform certain actions in the game, retain high situational awareness of the environment around them, react to multiple types of visual and audio stimuli, and juggle multiple concurrent tasks or objectives.

Players who are stronger in certain skills may be more suited for certain roles on a team when playing the game. By assessing player skills, players can be placed in positions on a team most suited for their individual abilities. In addition, players may wish to be able to continue training their skills, even when not playing the game. This may be similar to how a conventional athlete (e.g., a soccer player) may train in specific skills needed for their game such as decision making or mechanical outplays (e.g., by performing certain drills such as passing drills, shooting drills, etc.) outside of playing the actual game.

The systems and methods herein provide a player training/assessment tool for assessing a player's level of skill in various categories, and aid the player in training and improving their skills in those categories. In some embodiments, different types of skills common to different types of games are assessed and trained. These may include mechanical, background processing, situational awareness, executive function, decision making, communications, and multitasking skills. In some embodiments, the tool provides an environment that prompts the player to perform certain actions that utilize these different skills, allowing for these skills to be measured and/or trained. The training/assessment can also be individualized to the user's needs based upon the game that they're playing, the role they playing in the game, as well as their past-assessed performance in the different cognitive abilities (e.g., in order to bring certain skills that are lacking up to par, or to focus on more critical game related cognitive abilities).

Mechanical skills may refer to a player's ability to execute commands using a control interface (e.g., keyboard, mouse, game controller, and/or any combination thereof). Many games require a player to respond to visual and audio stimuli with a certain amount of speed, precision, and accuracy. For example, a shooter game may require a player to be able to execute commands to fire their weapon at targets that appear within the gaming environment. In order to hit the targets, the player may need to exhibit sufficient reaction time and precision.

Background processing may refer to the ability of a player to track the behavior of several different areas within the game environment at once, and to be able to keep a mental picture of how certain areas within the game environment will be expected to behave, without needing to constantly pay attention to those areas. For example, a game may require a player to be able to monitor certain aspects of the game interface (e.g., a cooldown timer, a mana gauge, a health bar, etc.) and perform an action when certain conditions are reached (e.g., launching an attack when a cooldown timer is reset and/or when a sufficient amount of mana is obtained, or drinking a potion to replenish health when health is low). Players that exhibit high proficiency in background processing may be able to pinpoint critical cues that indicate correct timing or information for the actions they are required to do.

Situational awareness may refer to the ability of a player to split their attention between different between different areas of the game environment, or notice events in the game environment that are not dominating the screen. For example, many games may display, on a portion of the game interface, a sub-display such as a mini-map or radar. The sub-display may indicate to the player events in the game that are not currently dominating the main game screen (e.g., approaching enemies, obstacles within the game environment, etc.). As such, by noticing events occurring within the sub-display that are not currently the main focus within the game environment, the player may be able to perform actions that improve their performance within the game (e.g., anticipating changes in the main game environment, such as by intercepting enemies before they become visible in the main display area). Situational awareness may be differentiated from background processing in that it may rely upon being able to identify events or cues that may or may not be occurring at a given time, instead of monitoring elements that are expected to behave in a predictable manner.

Multitasking may refer to the ability of a player to switch between different tasks rapidly and to afford sufficient attention to each one. For example, real-time strategy (RTS) games may require a player to rapidly switch between management of resource gathering and base building to directing combat between units (possibly on multiple fronts). In MOBA games, a player may need to control combat between a character under their control and opposing characters, while also managing item usage and ability cooldowns, and maintaining awareness of possible approaching threats as shown on a mini-map.

To be competitive at certain games, a player may need to be able to exhibit certain levels of each of these skills. For example, as discussed above, players of different types of games may need to be able to simultaneously perform different actions requiring different types of skills. As such, it may be important, especially in professional or competitive settings, to be able to assess and train a player on these skills. In addition, by being able to assess the player's abilities in each of a plurality of different skills, the player may be assigned to roles in the game that best take advantage of their strengths and weaknesses. For example, in some games, such as MOBAs, class-based shooters, etc., players may control different avatars, characters, or heroes that require different amounts of skill in different areas in order to be played effectively. For example, in the MOBA game LoL, certain champions (e.g., Lee Sin) are more mechanically demanding, and thus are better suited to be played by players with high mechanical skill, while other champions (e.g., Sejuani, Shyvanna, etc.) are less mechanically demanding, and as such are better played by players with lower mechanical skill, but may still require a high amount of background processing skill and/or situational awareness. In addition, some games may have different roles to be performed by players on a team that require different levels of certain skills (e.g., mid lane, jungle, etc.)

Many types of games may require players to have a certain set of common skills. For example, a player who is proficient in playing a particular shooter game may be able to transfer much of their mechanical skill, background processing, and situational awareness skills to other shooter games. On the other hand, certain types of skills may be more game-specific, such as the ability to make decisions or plan actions based upon the rules of a particular game.

System Overview

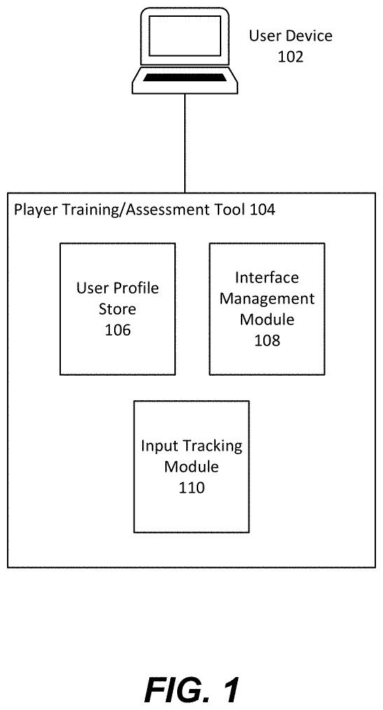

FIG. 1 illustrates a system for player training and assessment, in accordance with some embodiments. The system 100 comprises a user device 102 and a player training/assessment tool 104 in communication with the user device 102. In some embodiments, the player training/assessment tool 104 may be a server or implemented on a server that communicates with the user device 102 over a network (e.g., the Internet). In some embodiments, the player training/assessment tool 104 is local to the user device 102 (e.g., part of or directly connected to the user device 102).

The user device 102 corresponds to an electronic device capable of receiving user input as well as transmitting and/or receiving data to and from the player training/assessment tool 104 (e.g., via a network). In one embodiment, a user device 102 is a conventional computer system, such as a desktop or a laptop computer. Alternatively, a user device 102 may be a device having computer functionality, such as a game console, a personal digital assistant (PDA), a mobile telephone, a smartphone, a tablet computer, or another suitable device. In one embodiment, the user device 102 executes an application allowing a user (e.g., a player) to interact with the player training/assessment tool 104. For example, the user device 102 may execute a browser application to enable interaction between the user device 102 and the player training/assessment tool 104 via a network (not shown). In another embodiment, the user device 102 interacts with the player training/assessment tool 104 through an application programming interface (API) running on a native operating system of the client device 110, such as IOS® or ANDROID™. The user device 102 comprises a display for displaying content received from the player training/assessment tool 104 to the user of the user device 102. For example, the user device 102 may present content items via a browser application or an API running on the native operating system of the user device 102. The user device 102 further comprises one or more input devices for receiving user inputs, such as a keyboard, mouse, gamepad, joystick, or any combination thereof.

The player training/assessment tool 104 comprises a plurality of modules usable to generate interfaces for training and assessing a user's skill level. For example, as illustrated in FIG. 1, the player training/assessment tool 104 comprises a user profile module 106, an interface management module 108, and an input tracking module 110.

The user profile module 106 maintains a record of one or more user profiles. Each user of the system 100 (e.g., players) may be associated with a corresponding user profile. The profile of a user may store one or more attributes of the user, such as an assessment of the user's skill level in one or more skills, one or more user preferences (e.g., an indication of which skills the user is most interested in training), records of previous user assessment or training sessions, and/or the like. In some embodiments, a user of the user device 102 may access their profile to begin an assessment or training session by providing authentication information (e.g., a username and password).

The interface management module 108 is configured to generate and manage an interactive interface to be presented to the user at the user device 102 that are suitable for training and/or assessing a proficiency level of the user in a plurality of different skills. The generated interface comprises a game environment configured to provide a series of prompts to the user over a period of time (e.g., a “session”) that prompt the user to react and input one or more responses to the provided prompts. As used herein, a “session” may refer to a period of time over which the interface management module 108 presents an interactive interface to the user for skills assessment and/or training. In some embodiments, when a user accesses that player training/assessment tool 104, the user may begin a session (e.g., by clicking on a “New Game” icon in a menu), specify whether the session is for training or assessment, specify one or more session settings (e.g., difficulty level, session length, etc.), and/or the like. The prompts may include visual elements that appear or change within generated interface, such as targets that appear in the interface, progress bars that change within the interface, and/or the like. In some embodiments, prompts may include elements other than visual elements, such as audio elements, haptic feedback elements, and/or the like. For example, the interactive interface may present to the user visual elements (e.g., via a display screen), audio elements (e.g., through an audio device such as speakers, headphones, etc.), or some combination thereof.

The relationships between the provided prompts and user responses during a session can be analyzed to determine one or more metrics indicating proficiency of the user in one or more skill categories. In addition, the generated interface may be used to train the user by providing prompts for the user to input responses in a way that challenges the user, helping the user train and increase their proficiency in certain skills.

Examples of generated interfaces are described in greater detail below. In some embodiments, one or more properties of the generated interface are determined based upon one or more session parameters (e.g., difficulty level). The session parameters may be input manually by the user and/or determined automatically based upon one or more attributes of the user. For example, a difficulty level for the interface may be based upon a previous assessment of the user's proficiency in one or more skills, in order to allow for the interface to provide a training experience to the user that is challenging but still manageable for the user. Each difficulty level may comprise a predetermined set of attributes of the prompts provided by the interface to the user (e.g., rate at which prompts are provided, size or speed of the prompts, etc.).

The input tracking module 112 is configured to track inputs from the user at the user device 102. As the user interacts with the interface generated by the interface management module 108, the input tracking module 112 may monitor and record user inputs. In addition, the input tracking module 112 may determine an effect of the received inputs on the game environment of the generated interface, based upon one or more parameters of the received inputs. For example, the input tracking module 112 may record the user firing at a target displayed in the interface, and determine whether the user successfully hit the target or missed based upon a location associated with the firing and the current locations of one or more targets within the game environment. These results of the inputs may be used to determine metrics indicating a level of user proficiency in one or more skills.

Assessment/Training Interface

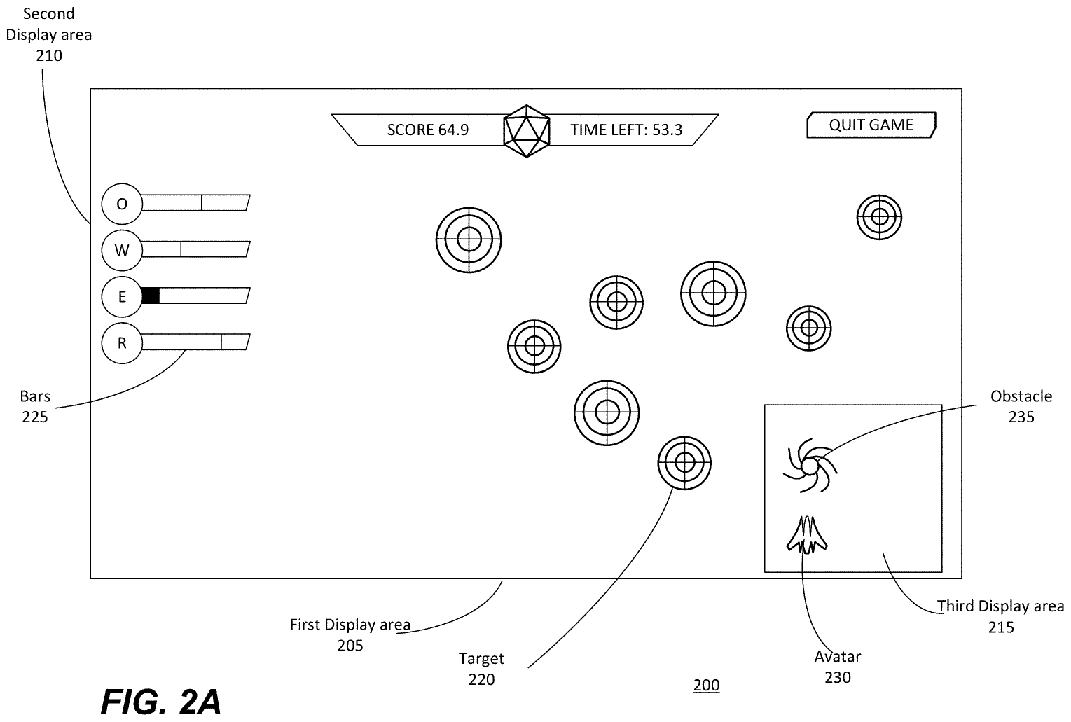

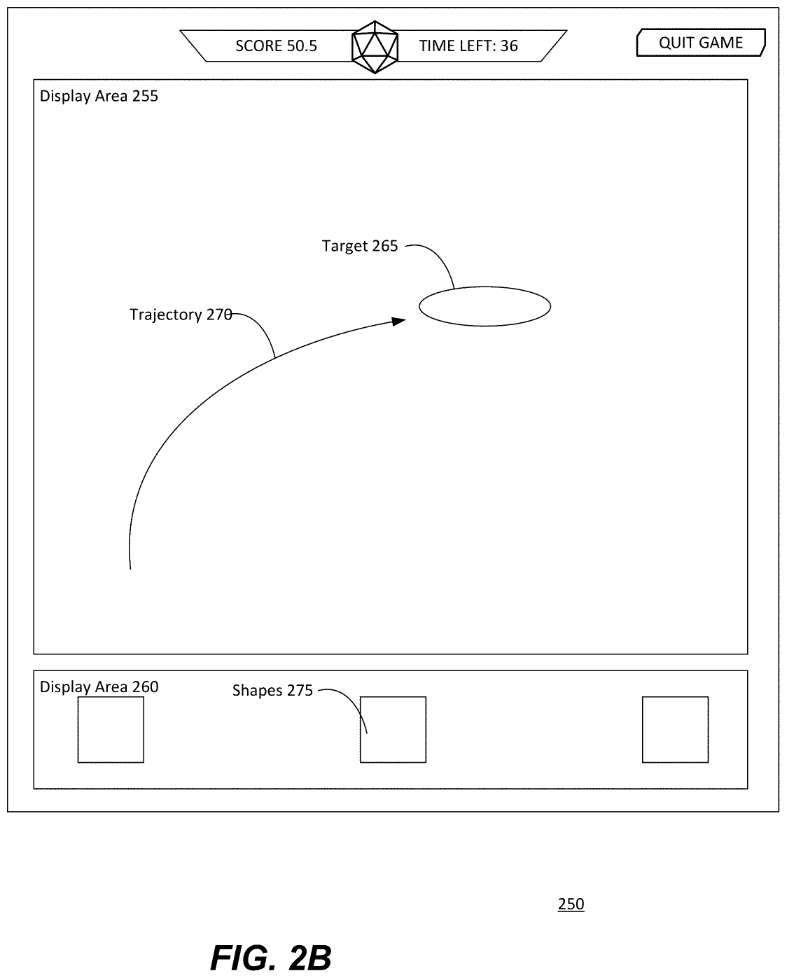

FIG. 2A illustrates an example of a generated game interface that may be used to assess and train user skills, in accordance with some embodiments. The interface 200 may comprise a display having a plurality of different display areas, including a first display area 205, a second display area 210, and a third display area 215. It is understood that while FIG. 2 illustrates three display areas in a certain arrangement, in other embodiments the interface may have a different number of display areas, and/or display areas in different locations. In some embodiments, the arrangement of display areas in the interface 200 may reflect an arrangement of display areas present in one or more competitive videogames. For example, many competitive video games may have an interface that displays a mini-map or other interface element at a corner of the interface (e.g., lower right corner). As such, the interface 200 may be configured such that the third display area 215 is located in a corner of the interface 200 in a similar location as where a mini-map may be located. In some embodiments, the interface 200 is related to a set of games that are of interest to the user (e.g., games that require skills trained by the interface 200). In some embodiments, the interface 200 may be configured (e.g., by the user) such that the arrangement of display areas (e.g., the position and size of each display area) more closely approximates the interfaces for a particular set of games. This may allow a user of the interface 200 to quickly become familiar with the interface 200, and more easily transfer skills trained through sessions using the interface 200 to the set of games that are related to the interface 200.

Each of the different display areas 205, 210, 215 may be configured for assessing or training a different category of skill of the user (by itself or in combination of other display areas). For example, in some embodiments, the first display area 205 is used to assess/train mechanical skill and reaction time of the user, the second display area 210 is used to, in combination with the remaining display areas, assess/train background processing skills of the user, and the third display area 215, in combination with the remaining display areas, is used to assess/train situation awareness skills of the user. By providing a plurality of different display areas at the same time, the user is assessed/trained in a plurality of different skill categories simultaneously. This may additionally allow for assessment/training of additional types of skills, such as multitasking skills, based upon a combination of other skill types being assessed/trained.

In some embodiments, as the user performs inputs in response to prompts (e.g., visual elements) provided by the interface 200, a current performance of the user may be assessed by calculating a metric based upon the inputs and prompts. In some embodiments, the metric may be expressed using a numerical or point value. For example, certain actions performed by the user indicating proficiency in a particular skill (e.g., hitting a certain area of a target, activating a button within a designated time window) may result in the user being awarded with a positive number of points, while actions indicating lack of proficiency (e.g., missing the target, letting a target despawn within firing upon the target, activating the button outside the designated time window) may result in no points being awarded or a deduction of points. In some embodiments, different types of points corresponding to different types of skills are awarded based upon different actions by the user, allowing for a plurality of different metrics, each corresponding to a different skill, to be determined for the user over a given session.

In some embodiments, the interface 200, at the first display area 205, assesses or trains the user's mechanical skills by providing a first set of prompts to cause the user to input a first set of inputs in response. In some embodiments, the first set of prompts may be displayed to the user in the form of targets 220 (e.g., bullseyes) for the user to hit. The user may hit a target 220 by moving a pointer or crosshair using a mouse, joystick, or other input device to a location of the target and performing a designated action (e.g., left-clicking the mouse, pushing a particular button on a gamepad, etc.) to activate the pointer and “fire” at the target. Each of the targets 220 may spawn (e.g., appear on the interface 200) at different times, and remain for a period of time before despawning (e.g., disappearing from the interface 200).

The targets 220 displayed to the user in the first display area 205 may be displayed in random locations and at random intervals in accordance with one or more difficulty settings. For example, the targets 220 may be displayed at more frequent and/or unpredictable intervals for higher difficulty levels, or at less frequent or more predictable intervals for lower difficulty levels. In addition, based upon the one or more difficulty settings, the duration of time each target 220 is displayed and the sizes of the displayed targets 220 may be configured. In some embodiments, one or more sets of mathematical logic rules may be used to limit the randomness of displayed target locations, intervals, durations, and size of the displayed targets such that the difficult levels of different sets of spawned targets will be relatively constant for a given difficulty level.

In some embodiments, one or more visual effects may be applied to a target 220 (e.g., growing or shrinking in size, changing color) in order to indicate a remaining amount of time the target 220 is expected to be visible within the display area 205 and thus can be hit by the user. For example, in some embodiments, a target 220 may appear to be growing in size when first spawned in the display area 205, until it reaches a predetermined size, and then begins to shrink in size before despawning from the display area 205.

The user's mechanical skill may be assessed based upon their ability to hit the displayed targets as they are displayed. For example, each time the user “fires” (e.g., by performing a designated action such as left-clicking a mouse, pressing a designated button on a keyboard or gamepad), a location of a pointer or crosshair of the user is identified, and a determination is made as to whether the user hit a target based upon the identified location and the current positions of the displayed targets. In addition, in some embodiments, if a “hit” is determined, a location on the target 220 may be identified. The user is awarded points for successful hits to the displayed targets 220. In some embodiments, the amount of points awarded may be based upon an area of the target 220 that is hit (e.g., full points for center area, partial points for other areas, based upon distance from the center area). On the other hand, “misses” (e.g., where the user “fired” at a location outside a displayed target 220) and/or despawning of targets that were not fired upon may result in no points or a deduction in points. For example, in a particular embodiments, a hit may reward a user with 1 point, a miss penalizes the user 1 point, and a despawning target does not award or penalize any points. In some embodiments, how points are awarded/penalized may be based upon a selected difficulty level. For example, a harder difficulty levels may award less points and/or penalize more points (e.g., 1 point for a hit, −2 points for a miss, −1 points for a despawned target).

In some embodiments, in addition to targets 220 for the user to hit, one or more “negative” targets may be spawned and despawned within the first display area 205 during a session. The negative targets may be visually distinguishable from the targets 220, and may penalize the user when hit (e.g., point penalty). As such, the user is forced to distinguish between the targets 220 and negative targets, instead of indiscriminately firing upon any target that appears.

In some embodiments, the first display area 205 may display prompts to assess or training the user's mechanical skills in other ways. For example, the first display area 205 may display a series of prompts prompting the user to input a certain combination of inputs (e.g., button presses or keystrokes) within a certain period of time. In some embodiments, the first display area 205 may display elements suitable for assessing/training different aspects of the user's mechanical skills, such as presenting a target to be followed by the user in order to test the user's tracking aim instead of their flicking aim, prompting a user to drag and release an object in a direction and velocity such that the object travels into a particular zone of the display area (e.g., based upon a physics engine) that tests the user's control as well as their knowledge of the physics engine. Other types of prompts that may be presented by the interface to assess different aspects of the user's mechanical skill may include interface elements that prompt the user to perform a specific combination of key strokes (e.g., based upon visual or audio instructions), navigate an object through a maze without touching certain obstacles, and/or the like. In some embodiments, multiple different types of prompts may be displayed during concurrent time periods (e.g., in order to assess different aspects of the user's mechanical skills simultaneously), over sequential time periods (e.g., in order to assess different aspects of the user's mechanical skills in sequence), and/or the like.

In some embodiments, the second display area 210 of the interface 200 is used to assess or train a background processing ability of the user. As discussed above, background processing may refer to the ability of the user to pay attention to different aspects of the game environment (e.g., different areas of a display, which at a given time may include elements that are currently visible or not) and respond to different types of cues. As such, to assess or train a user's background processing ability, background processing assessment/training at the second display area 210 is performed concurrently with the assessment/training of mechanical skill at the first display area 205, in order to split the user's attention between the first and second display areas of the interface 200.

In some embodiments, the second display area 210 displays a plurality of visual elements that prompt the user to perform certain inputs during designated time periods. For example, as illustrated in FIG. 2, the visual elements may comprise a plurality of progress bars 225 that change in length (e.g., depleting) over time at varying rates, wherein the user is prompted to perform a designated action (e.g., press a button corresponding to the bar) when a bar of the plurality of bars has a length within a threshold range (e.g., a threshold length or below). For example, interface 200 as illustrated in FIG. 2 contains four bars 225, corresponding to the buttons “Q”, “W”, “E”, and “R” on a keyboard.

In some embodiments, a visual effect may be applied on a bar when the bar has reached the threshold length (e.g., a color change) to indicate to the user that the action should be performed. In some embodiments, if the user successfully performs the action (may be referred to as activating the bar), the bar 225 will reset to its full length, whereupon it will continue depleting to prompt the user to perform the action again at a later time. On the other hand, if a user waits too long and allows a bar 225 to completely deplete, the bar may be “locked” for a designated period of time, during which the bar will remain static and unresponsive to user actions. Points may awarded for successful activations of the bar 225, and deducted for attempted activations when bar is not within the threshold range, and for allowing a bar to completely deplete and “lock.” The ratio of awarded points to deducted points may be based upon a difficulty level of the session.

The rate of change in the length of the bars 225 may be randomized to prevent the user from simply memorizing a pattern or timing of actions to be perform, and instead require the user maintain awareness of the second display area 210, even as they are attempting to hit targets 220 within the first display area 205. In other embodiments, instead of the bars 225 illustrated in FIG. 2, the visual elements of the second display area 210 may correspond to any type of visual element that may visually change over time in such a manner that the user is prompted to perform certain actions during certain time intervals. In some embodiments, one or more of the bars 225 or other visual elements may become invisible during certain time periods, prompting the user to maintain awareness of the visual elements when they are visible and predicting when they will need to perform corresponding actions.

In some embodiments, the designated action to be performed by the user based upon the condition of the bars 225 (e.g., a bar reaching a threshold length or below) may be selected as an action that requires minimal mechanical skill. For example, as discussed above, the designated action may be the pressing of a button corresponding to the particular bar 225. As such, the user's ability to perform the action will largely be dependent upon their ability to maintain awareness of the current state of the bars 225, and less upon mechanical speed, precision, or dexterity (e.g., unlike the hitting of the targets 220 in the first display area 205, which requires the user be able to accurately control a position of a pointer or crosshair). This allows for the interface 200 to be able to more accurately assess or train the background processing ability of the user while minimizing influence by the mechanical skill or lack thereof of the user. For example, a user having poor mechanical skill may still be able to demonstrate proficiency in background processing skills and train their skill using the interface 200.

The third display area 215 may be used to assess/train the situational awareness of the user. As discussed above, situational awareness may refer to the ability of the user notice actions that are currently not dominating the screen, such as on a radar or mini-map within a game. In some embodiments, the third display area 215 displays one or more objects that may be displayed in certain arrangements. Particular arrangements of the one or more objects within the third display area 215 may be referred to as events. Events may occur at particular intervals as objects within the third display area 215 spawn and despawn, and/or move within the display area.

For example, in some embodiments, the third display area displays an avatar 230 of the user that may illustrate a current position of the user in the game. This may be similar to how a location of a player within a game environment may be reflected in a mini-map displayed to the player. During a session, obstacles 235 are presented in the third display area 215 to the user, whereupon the user may be prompted to perform an action based upon based upon the current position of the avatar 230 and the obstacle 235 in the third display area 215. For example, the user may perform an action the move the avatar 230 to an opposite side of the third display area 215 from the obstacle 235 (e.g., using left or right arrow buttons on a keyboard, a designated pair of keyboard buttons such as “F” and “D,” a joystick on a gamepad, etc.).

In some embodiments, the user is prompted to perform a designated action in response to certain events, but not to other events. For example, if the obstacle 235 appears on the same side of the display area as the avatar 230, then the user is prompted to enter an input to move the avatar 230 to the other side of the screen. However, if the obstacle 235 appears on the opposite side of the third display area 215 as the avatar 230, then the user does not need to enter any input. As such, the user may be prompted to respond to certain types of events (e.g., “meaningful events”), but not other types of events (e.g., “background events”). In some embodiments, if the user fails to respond to an event within a specified period of time, the interface 200 may change one or more visual properties, or prevent the user from performing one or more actions. For example, if the user does not respond in time to an obstacle 235 appearing on the same side of the display area 215 as the avatar 230, the obstacle 235 may move such that the avatar 230 appears to “collide” with the obstacle 235, the user may be prevented from performing actions in the first display area and/or the second display area (e.g., hitting any of the targets 220). This may be done in order to simulate the property of mini-maps or radar in many games in which events occurring in the mini-map or radar are also reflected on a main area of the game environment.

In some embodiments, the user may receive points for successfully reacting to meaningful events (e.g., performing an input to move the avatar 230 to an opposite side of the third display area 215 within a predetermined time of an obstacle 235 appearing on the same side as the avatar 230), and may receive no points or be penalized points for failing to react to the events. For example, if the user does not respond to a meaningful event within a predetermined period of time, points may be deducted continuously at a set rate until the user performs the necessary action.

In some embodiments, the interface 200 may be configured such that the user is not prompted to react to events in the third display area 215. Instead, events in the third display area 215 may be used to indicate or forecast events to occur in other areas of the interface 200 (e.g., within the first display area 205), whereupon users are assessed based upon their ability to react to the events within the other area.

As illustrated in FIG. 2A, the third display area 215 may be located at an opposite side of the interface 200 as the second display area 210. This forces the user to switch their attention over a wider area of the interface 200 in order to be able to keep up with the prompts presented at each of the different display areas.

While the above discussion refers primarily to the interface 200 displaying visual elements (e.g., targets 220, progress bars 225, etc.) prompting the user to perform certain actions (e.g., hitting the targets, pressing a designated button when a bar has reached a certain length, etc.), in some embodiments, audio elements may be used instead of or in addition to visual elements to prompt the user to perform certain actions. For example, in some embodiments, the interface 200 may assess or train a situational awareness of the user by prompting the user to perform certain actions in response to hearing certain audio cues (e.g., while their attention is focused on hitting spawned targets).

By simultaneously presenting different display areas to the user, the interface 200 allows for concurrent assessment or training of multiple different types of skill for the user. In addition, as discussed above, certain types of skills, such as background processing or situational awareness, may be difficult or impossible to accurately assess or effectively train in isolation, as they require the user's attention to be divided between different areas of the game environment. As such, through the use of different display areas with different types of prompts, the interface 200 forces the user to divide their attention between them, providing an environment for assessing or training such skills. By requiring the user to respond to prompts using different types of actions, the interface 200 can differentiate between different types of skills being assessed or trained, allowing for each skill to be trained or assessed independently (e.g., actions associated with background processing may require little or no mechanical skill, and thus allowing for the user to demonstrate proficiency in background processing even if their mechanical skills are low).

In addition, by concurrently assessing/training multiple different types of skills, the user's ability to multitask can be assessed or trained. Multitasking skill is not directly measured using a display area of the interface 200, but may be determined using a separate metric based upon the user's performance in other categories of skills. In some embodiments, a multitasking metric may be determined based upon a disparity between metrics determined for each one or more other skill categories (e.g., mechanical skill, background processing, situational awareness). For example, a first user assessed as having a high amount of mechanical skill (e.g., 100 points) but a low amount of background processing skill (e.g., 20 points) may be determined to have a lower multitasking metric in comparison to a second user with mechanical skill and background processing skill scores that are closer in value (e.g., 60 points each). As such, a user who focuses most of their attention on one display area/skill at the expense of others would perform poorly in multitasking. In some embodiments, the values of the multitasking metric for the user is inversely proportional to a disparity between two or more of the individual skill metrics for the user.

While FIG. 2A illustrates a particular number and arrangement of display areas, each configured to provide different elements for display to user that prompt the user to perform different types of actions, in other embodiments, the interface may have a different number or arrangement of display areas, and display different elements prompting different actions. FIG. 2B illustrates another example of an interactive game interface that may be used to assess and train user skills, in accordance with some embodiments. As illustrated in FIG. 2B, the interface 250 contains a first display area 255 and a second display area 260. The first display area 255 may display elements that prompt the user to perform actions requiring a degree of mechanical skill (such as firing at one or more targets 265 moving along one or more different trajectories 270), while the second display area 260 contains elements prompting the user to perform actions to do not require a significant amount of mechanical skill (such as activating buttons corresponding to each of a plurality of displayed shapes 275 when certain conditions are met). By simultaneous displaying elements in both the first and second display areas that prompt different types of user action, the user is forced to split their attention between the first and second display areas, allowing for the second display area 260 of the interface 250 to be used for measuring skills such as background processing and/or situational awareness. In addition, the prompting of users to perform different actions in response to different displayed elements simultaneously allows for an ability of the user to multitask to be measured.

In some embodiments, although the above figures illustrate each display area displaying a certain type of element prompting the user to perform a corresponding type of action, in some embodiments, the types of elements and the prompted actions within a display area may change over the course of a session. For example, in some embodiments, the first display area may display a set of elements that prompt the user to perform a first type of action over a first time period of the session (e.g., fire at red targets but not blue targets). However, the interface may display one or more additional display elements that may change in appearance in order to indicate to the user a change in conditions (e.g., changing background color of the display area or other type of indicator), such that the user is prompted to perform a second different action over a second time period based upon the same set of elements (e.g., fire at blue targets instead of red targets). In some embodiments, the ability to the user to react to changing conditions (e.g., by measuring the performance of the user shortly before and after a condition change) may be used to assess a situational awareness or other skill of the user.

While FIGS. 2A and 2B illustrate example interfaces with three and two different display areas respectively, it is understood that in other embodiments, the interface may contain additional display areas for use in assessing/training additional skills of the user. In addition, in some embodiments, multiple display areas may be used to assess/train a single skill of the user. For example, in order to assess/train a situational awareness skill of the user, the interface may provide appropriate prompts in two or more different display areas of the interface, forcing the user to maintain awareness of a large number of different display areas.

In some embodiments, the elements provided by the interface may include audio elements in addition to visual elements. For example, during a session the user may be given a set of audio prompts which prompt the user to perform certain actions, such as audio prompts indicative of an impending event that the user must react to. In some embodiments, audio elements may be used instead of or to supplement visual elements displayed to the user in training or assessing various skills. For example, particular audio cues may be used to indicate a meaningful event for the user to respond to. In some embodiments, audio prompts may be used in conjunction with visual prompts. For example, an audio effect may be played to the user to indicate the presence of displayed visual element, a characteristic of a visual element (e.g., rising pitch indicating an increase in a rate of change of a visual element, while falling pitch indicating the opposite), and/or the like.

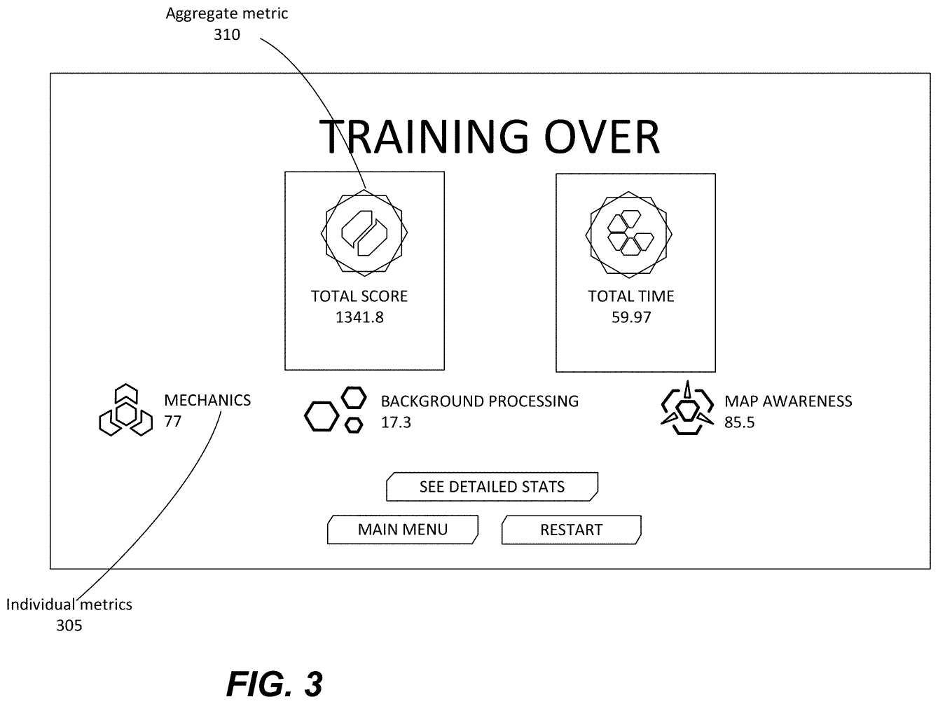

After a session, the interface management module 108 may generate a metrics page viewable by the user indicating the metrics for different skills determined during the session. FIG. 3 illustrates an example metrics page, in accordance with some embodiments. For example, as illustrated in FIG. 3, separate individual metrics 305 for a plurality of different skills (e.g., mechanical skill, background processing, and situational awareness) may be displayed. The metrics may have been determined using any of the techniques described above. In addition, a total or aggregated metric 310 may be determined based upon each of the individual metrics. In some embodiments, the aggregated metric may encompass a multitasking metric determined based upon a disparity or spread of the individual skill metrics. In other embodiments, multitasking may be displayed as its own separate metric.

In some embodiments, a user may select an individual metric 305 or other interface element (e.g., a “See Detailed Stats”) button, in order to view a detailed stats page displaying one or more additional metrics used to calculate the individual metrics 305 and/or the aggregated metric 310. For example, the detailed stats page may indicate one or more components of an individual score (e.g., hits and misses for mechanical skill) and/or one or more categories within a particular skill (e.g., in embodiments that include different types of targets or actions associated with assessing mechanical skill, metrics for sub-skills such as flicking aim and tracking aim may be included).

In some embodiments, the determined metrics for each skill (as well as the aggregated metric) may be given a ranking or category (e.g., Poor, Below Average, Average, Above Average, Excellent, or Pro), allowing for the skills of a particular to user to be quickly assessed at a glance.

Communications Skills

In some embodiments, multiple users may be able access the player training/assessment tool 104 and utilize the generated interfaces (e.g., as illustrated in FIGS. 2A and 2B) for training and/or assessment of various skills. For example, while FIG. 1 illustrates a single user device 102 in communication with the player training/assessment tool 104, it is understood that in some embodiments, multiple users at multiple different user devices 102 may communicate with the player training/assessment tool 104 for skill training/assessment. In some embodiments, different users may each have their skills assessed over one or more sessions, which can be compared with each other to determine the relative skill levels of the different users.

In some embodiments, two or more players may be able to utilize the player training/assessment tool 104 concurrently in order to train or assess a communications skill of the users. For example, the player training/assessment tool 104 may be configured to generate interfaces to be presented to two or more users at different user devices 102 simultaneously, where each interface presented to the different users may contain different information (e.g., different events or prompts) in a manner such that the users, in order to most effectively respond to the events or prompts presented to them by their respective interface, may need to rely upon inputs or communication from other users.

In some embodiments, during a session involving both a first user and a second user, a first interface presented to the first user may indicate to the first user an event that will appear at a future time at a second interface presented to the second user, that the second user is expected to react to. The event may correspond to any of the events or prompts discussed above (e.g., a spawning target, a potential collision between an avatar and an obstacle, etc.). In some embodiments, the event may be configured to occur in such a way that it will be difficult or impossible for the second user to react to without having received prior knowledge of the event (e.g., a spawning target that despawns very quickly, the obstacle moving at a speed such that the second user, without prior knowledge, is not expected to be able to move the avatar quickly enough to avoid collision). The first user may communicate the event to the second user via one or more inputs. For example, the first user may press one or more buttons that cause an indicator to appear on the second interface notifying the second user of the event, click a location on the first interface corresponding to the event that causes a marker to appear on a corresponding location of the second interface alerting the second user to the event. In some embodiments, the first user may communicate with the second user through speech (e.g., via a microphone).

In some embodiments, communications skills may be assessed or trained in parallel with one or more other skills (e.g., mechanical skill, background processing, situational awareness, etc.). For example, as discussed above, a mechanical skill of a first user may assessed using the first interface by measuring the first user's ability to hit spawning targets (e.g., within the first display area 205). In some embodiments, certain events (hereafter referred to as “event indicators”) may be marked to indicate to the first user that a corresponding event will occur at the second interface presented to the second user (e.g., a particular spawn target may be of a different color, indicating that a corresponding target will spawn at a corresponding location on the second interface). The first user is prompted to perform an input different to how the first user would normally react to the event (e.g., right-clicking on the target instead of left-clicking) indicating one or more characteristics of the event (e.g., the location of the target). In response to the received input, the player training/assessment tool 104 causes the second interface to display to the second user an indication corresponding to the event (e.g., a ping at a corresponding location on the second interface), allowing the second user to receive information regarding the corresponding event before it occurs, such that they will be able to react to the event.

In other embodiments, the received input may comprise audio information (e.g., speech by the first user describing the corresponding event). As such, the player training/assessment tool 104, instead of displaying an indication on the second interface, may provide the audio information to the second user, allowing the second user to be aware of the event.

In some embodiments, the corresponding event may be configured to be visually different from other events (e.g., a different color target) and be configured such that it will be difficult or impossible for the second user to react to successfully without having received prior information (e.g., by reducing an amount of time in which the second user is able to respond to the event, such as a target that despawns much more rapidly compared to other targets). In other embodiments, event indications may correspond to events displayed by the first interface associated with the training/assessment of other skills (e.g., situational awareness, background processing, etc.).

In some embodiment, if the first user fails to communicate to the second user in response to an event indication (e.g., performing an input indicative of at least one characteristic of the corresponding event within a predetermined period of time), then the corresponding event may appear to the second user as a normal event (e.g., target of the same color, and despawn time that is line with those of other targets). This may be done in order to avoid penalizing the second user for a failure to communicate from the first user. In other embodiments, the corresponding event may still occur, however, the second user is not penalized for failing to react to the corresponding event.

The communication skill of the first user may be assessed based upon how quickly they are able to communicate the event indicator to the second user, an accuracy of the communication, and/or the like. In some embodiments, the communication skill of the first user may further be assessed based upon whether the second user was able to successfully react to the corresponding event. Because the corresponding event may be configured to be extremely difficult for the second user to react to without prior knowledge of the event, the second user being able to successfully react to the event may thus be indicative of a successful communication by the first user. In some embodiments, a metric for assessing the communication skill of the first user may be adjusted based upon a level of skill of the second user in a skill corresponding to the corresponding events (e.g., such that the first user will not be unfairly penalized if the second user lacks sufficient skill to respond to the corresponding events, even when effectively communicated by the first user).

Difficulty Levels

In some embodiments, how the interface 200 provides the various elements prompting user action during a session may be configured based upon one or more difficulty settings. Different types of elements provided by the interface (e.g., targets 220, bars 225, etc.), may each be associated with one or more properties, such as a spawn rate, rate of change, movement speed, uniformity of behavior, and/or the like, each of which may be changed to raise or lower a difficulty level for the user. For example, the targets 220 in the first display area 205 may spawn at a more rapid rate to increase difficulty, or at a slower rate to lower difficulty. In addition, difficulty may be increased by reducing a size of the spawned targets 220, decrease a duration before each target 220 is despawned, allowing the spawned targets 220 to move within the display area 205, and/or the like. In some embodiments, each of a plurality of difficulty levels may correspond to a predetermined set of properties for the elements provided by the interface. Table 1 below illustrates some of the properties that may be adjusted for different skills to raise or lower difficulty level.

TABLE 1

| | | Background | Situational |
|---|---|---|---|
| | Mechanical Skill | Processing | Awareness |
| Properties | Spawn rate | Rate of change | Frequency of |
| | Duration before | Variability of | events |
| | despawning | change rate | Ratio of |
| | Size of targets | Threshold range | meaningful events vs. |
| | Movement of | Number of bars | background events |
| | targets | Visibility of | Time to react to |
| | Distribution of | bars | events |
| | targets within | Window of time | |
| | display area | during which | |
| | Presence/absence | input can be | |
| | of negative | received | |
| | targets | | |

In addition, in some embodiments, metrics for different skills may be determined differently based upon difficulty level. For example, higher difficulty levels may reward fewer points for positive actions (e.g., successfully hitting a target, performing an action in response to an event, etc.) and/or impose harsher penalties for negative actions (e.g., missing a target, not performing an action in response to an event or performing an incorrect action, etc.). In some embodiments, how metrics are determined for different difficulty levels may be normalized such that a player can expect similar metrics regardless of the difficulty level of a session.

Skill Assessment

In some embodiments, the training/assessment module 110 may configured one or more properties of the generated interface 200 based upon whether a particular session is for assessment or training. For example, in some embodiments, when a user selects an assessment session, the interface 200 may be configured to operate at a predetermined difficulty level and session length. This may facilitate comparing the abilities and skill levels of different users, as the metrics for different skills for each user generated via the assessment sessions will be controlled for difficulty level and session length. The predetermined difficulty level may be selected to be at a level expected to provide a challenge for most users, but not too overwhelming to be able to produce a wide range of metric values. The session length may be selected to be long enough to provide enough data for skill assessment, while not being too long so that players may experience fatigue and attention span issues.

In some embodiments, a user be required to play at least a threshold number of assessment sessions before their calculated skill metrics can be compared with those of other users. This may allow for a new user to gain familiarity with the interface 200 before being compared with other users. Different players may each play one or more assessment sessions, such that metrics for each of a plurality of skills can be calculated for each player. The levels of proficiency of each player in each of the plurality of skills (as determined by the metric values) may be compared against each other, to identify relative strengths and weaknesses of each player. In some embodiments, the different players may be members of a gaming team, whereupon each player is assigned to a different role in a game based upon their determined levels of proficiencies in the various skills. For example, in a team-based shooter game, a player having high mechanical skill may be assigned to a sniper role, while a player having lower mechanical skill but higher proficiency in background processing or situational awareness may be more suitable for a front-line tank role.

In addition, by assessing the skills of a user, the interface may generate one or more recommendations as to how the user may be able to improve in various games. Each recommendation may be based upon an assessed skill level of the user in a particular skill, relative levels of different skills of the user, one or more preferences of the user, or some combination thereof. For example, a player who prefers playing mechanically-demanding characters in a game but is assessed to have low mechanical skill may be recommended to train their mechanical skill and/or switch to a character that is less mechanical demanding. On the other hand, a player assessed as having low situational awareness and who frequency dies to ganks in MOBA games may be recommended to pay more attention to the mini-map in games and to train their situational awareness skill.

In some embodiments, the one or more recommendations may be based upon one or more specific characteristics of the user's input over one or more previous sessions. Because each of the user's inputs over a session may be recorded, the player training/assessment tool is able to perform detailed analysis into how different aspects of the user's input affected their score in each individual skill. For example, in one embodiments, the player training/assessment tool may determine that the user has a low score for the background processing skill because they often perform a particular action too early (e.g., pressing a button corresponding to a bar 225 before the bar has reached the threshold length). As such, the player training/assessment tool may generate a recommendation for the user that they practice holding off on performing an action until the correct conditions are reached.

Skill Training

As discussed above, a user may also use the player training/assessment module 110 to train in one or more skills. For training, a user may vary the difficulty level and/or length of the session to be provided with an experience that is challenging to them. In some embodiments, the training/assessment module 110 may automatically select a difficulty level, based upon a previous assessment of the user's skills (e.g., via an assessment session or previous training session). In other embodiments, the user may manually select a difficulty level based upon their knowledge of their own skill level and their desired level of challenge. In addition, the user may be able to manually select a session length.

During a training session, one or more skill metrics may be calculated for the user using the techniques described above. These metrics may be used to track the user's progress as they continue to train at that difficulty level. However, because different users may train at different difficulty levels and session lengths, skill metrics calculated during training sessions may not be able to be used to compare the skill levels of different users unless normalized.

In some embodiments, the user may specify one or more skills they wish to emphasize for a training session. The player training/assessment module 110 may, in response, configured a difficulty level of the session such that prompts associated with the selected skills will be more difficult to react to, while lowering a difficulty level associated with prompts of other skills, such that the user is not overwhelmed by trying the other skills. In some embodiments, the user can manually select a desired difficulty level for each of a plurality of skills independently.

In some embodiments, instead of configuring the interface based upon one or more predetermined difficulty levels, the player training/assessment tool may alter one or more parameters of a training session based upon specific characteristics of the user's inputs over one or more previous sessions. For example, the interface may determine, based upon recorded inputs from a user over one or more previous sessions, that the user is able to consistently hit targets presented within a central region of the first display area 205 of the interface, but displays less ability to consistently hit targets that are spawned in one or more peripheral areas of the first display area 205. As such, in order train the user's mechanical skills, the interface may configure a training session for the user such that a larger portion of displayed targets are presented in the peripheral areas of the first display area 205, challenging the user to pay more addition to those areas of the display. Based upon a record of the user's input over one or more previous sessions, the player/training assessment tool may identify a characteristic of the user's inputs (e.g., based upon the timing, location, and/or quality of the inputs) that could be improved in order to improve the user's skill metrics in a particular skill, and configure the interface in a subsequent session to present to the user prompts in such a way so as to challenge the user to improve that characteristic in order to maintain their score in the skill, and thus helping the user to further develop and improve their skill.

Process Flow

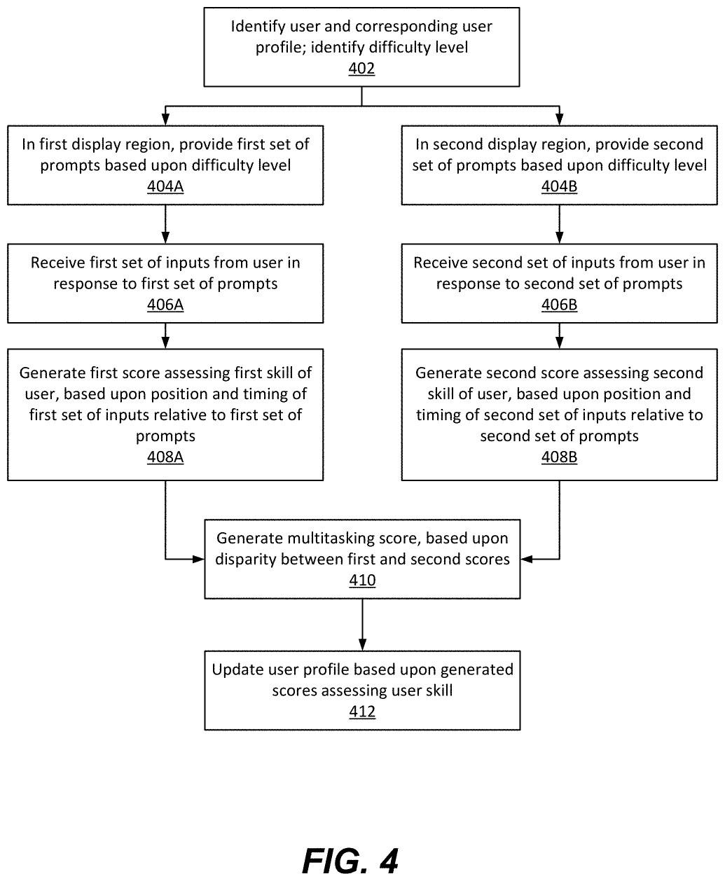

FIG. 4 is a flowchart of a process for assessing or training user skill using a game interface, in accordance with some embodiments. In some embodiments, the process is performed by the player training/assessment tool 104 illustrated in FIG. 1.

At 402, the player training/assessment tool identifies a user and corresponding user profile. In some embodiments, the user profile is identified based upon a username and password provided by the user when the user accesses the player training/assessment tool. In addition, the player training/assessment tool may identify one or more session settings such as a difficulty level and session length. In some embodiments, to assess the skill levels of the user in a manner that can be compared against other users, the difficulty level and session length may be preset. In other embodiments, the session settings may be manually input by the user, or automatically determined based upon a previous assessment of the user.

The player training/assessment tool starts an assessment session on a game interface for assessing the skill of the user, based upon the determined session settings. The game interface comprises at least a first display region and a second display region (e.g., the first display region 205 and second display region 210 illustrated in FIG. 2). At 404A, the first display region provides a first set of prompts based upon the selected difficulty level. In addition, at 404B, the second display region provides a second set of prompts based upon the selected difficulty level. Each of the first and second set of prompts may correspond to visual elements displayed within the respective display regions. For example, the first set of prompts may comprise spawning and despawning targets, while the second set of prompts may comprise bars of changing lengths, in which the user is prompted to perform a particular action in response to a bar reaching a certain length. The first and second sets of prompts may be provided over overlapping time periods, such that the user is forced to split their attention between the first and second display areas during the course of the session.

At 406A and 406B, the player training/assessment tool receives user inputs (e.g., a first set of user inputs and a second set of user inputs) in response to provided first set of prompts in the first display area and the second set of prompts in the second display area. In some embodiments, the user provides responses to individual prompts of each set of prompts as they are received, such that the time period over which the prompts are provided and the time period during which responses are received will overlap. In some embodiments, the first and second sets of user inputs may comprise different types of actions performed by the user. For example, the first set of user inputs may comprise actions that require a degree of mechanical skill (hitting a target by moving a pointer or crosshair to the target), while the second set of user inputs may comprise actions that require minimal mechanical skill (e.g., pressing a button).

At 408A and 408B, the player training/assessment tool generates respective first and second metrics indicating skill levels for the user, based upon the position and timing of the first and second sets of inputs relative to the first and second sets of prompts. For example, the player training/assessment tool may increase a metric corresponding to the first skill in response the user successfully performing an input of the first set of inputs in response to a prompt of the first set of prompts, or decrease the metric value in response to the user unsuccessfully performing the input (e.g., firing at a location outside a spawned target, pressing the button corresponding to a bar when the bar is no longer below the threshold length) or not performing the input in response to the prompt. In some embodiments, the player training/assessment tool updates and displays the metrics as throughout the session as prompts are provided and user inputs are received. In other embodiments, the player training/assessment tool may only display the determined metrics to the user at the end of the session.

In some embodiments, the player training/assessment tool may further provide additional sets of prompts to the user (e.g., in additional display areas), receive additional sets of inputs in response to the additional sets of prompts, and generated additional scores assessing additional skills of the user.

At 410, the player training/assessment tool generates a multitasking metric assessing a multitasking skill of the user, based upon a disparity between the individually-measured metrics (e.g., the first and second metrics). For example, in some embodiments, a higher multitasking metric may be determined for the user if the user's determined metrics for the first and second skill are relatively close in value, compared to if the user's metrics are highly disparate in value. In some embodiments, the multitasking metric may be determined based upon

$$\frac{1}{N} {\sum }_{j = 1}^{N} s\_j \times {e}^{- \frac{1}{L} {\sum }_{j = 1}^{N} {\sum }_{i = j + 1}^{N} \vert s \_ i - s \_ j \vert}$$

which may be rewritten as:

$$avg ( s\_ 1 , s\_ 2 , … s\_N ) \times {e}^{- \frac{1}{L} ( \vert s \_ 1 - s \_ 2 \vert + \vert s \_ 1 - s \_ 3 \vert … + \vert s \_ 1 - s \_ N \vert + \vert s \_ 2 - s \_ 3 \vert … + \vert s \_ ( N - 1 ) - s \_ N \vert )}$$

where N corresponds to a number of the individually-measured metrics (e.g., associated with scores s_1 through s_N corresponding to different skills), and L corresponds to a predetermined positive integer value (e.g., 30). In some embodiments, different constant values (L values) may be used to weigh different score disparity values differently.

At 412, the player training/assessment tool updates the user profile of the user based upon the generated metrics, such that the user profile reflects the current skill level of the user. In some embodiments, the generated skill metrics may be compared against skill metrics of other users. Based upon the comparison, the user may be picked for a gaming team or assigned to a particular role in the team. For example, different players may be ranked using different skill metrics, and players having particular skills may be assigned to roles most able to take advantage of those skills.

While the above disclosure primarily discusses the use of interactive interfaces to assess and train user skills in a gaming context, in other embodiments, the interfaces described herein may be usable for assessing and training user skills in other contexts. For example, an interactive interface may be used to train a user in various labor tasks (e.g., in a factory setting), in which the user needs to possess certain mechanical skills while maintaining an awareness of changing conditions in a surrounding environment (e.g., situational awareness). In other embodiments, the interface may be used to assess and train a user's skills in operating a vehicle or vehicle simulator, which typically require both mechanical skills and situational awareness or background processing skills. As such, the use of interactive interfaces for skill assessment and training may be applied to both occupational as well as recreational applications.

Additional Configuration Information

The foregoing description of the embodiments of the disclosure has been presented for illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A computer implemented method for assessing or training user skill level and game performance, comprising:
providing, to a user at a user device, an interactive game interface configured to:
within a first display area, present to the user a first set of prompts over a time period prompting the user to perform a first type of input; and
within a second display area, present to the user a second set of prompts over the time period prompting the user to perform a second type of input;
receiving, from the user during the time period, a first set of the first type of input in response to the first set of prompts, and a second set of the second type of input in response to the second set of prompts;
assessing a skill level of the user, by:
generating a first performance metric based upon position and timing of the received first set of inputs relative to the displayed first set of prompts, indicating a level of proficiency of the user in a first skill;
generating a second performance metric based upon a timing of the received second set of inputs relative to the displayed second set of prompts, indicating a level of proficiency of the user in a second skill;
generating an additional performance based upon a level of disparity between the first performance metric and the second performance metric, indicating an ability of the user to multitask; and
updating a user profile corresponding to the user, based upon the generated first, second, and additional performance metrics.

2. The computer implemented method of claim 1, wherein the interactive game interface is configured to present the first and second sets of prompts in accordance with a difficulty level corresponding to a set of predetermined attributes, selected from a plurality of difficulty levels.

3. The computer implemented method of claim 2, wherein the set of predetermined attributes of the difficulty level comprises at least a rate at which prompts of the first set of prompts are displayed on the interactive game interface, and a duration that prompts of the first set of prompts are displayed on the interactive game interface.

4. The computer implemented method of claim 2, wherein the difficulty level is selected based upon a previously determined performance metric associated with the user profile.

5. The computer implemented method of claim 1, wherein the first set of prompts comprises a plurality of targets displayed within the first display area at various times within the time period.

6. The computer implemented method of claim 5, wherein the an input of the first type of input comprises a controlled movement of a pointer by the user to a location within the interactive game interface over a displayed target of the plurality of targets, followed by an activation of the pointer by the user over the displayed target.

7. The computer implemented method of claim 6, wherein the first performance metric is based upon at least a number of targets of the plurality of targets that the user was able to successfully activate the pointer over.

8. The computer implemented method of claim 1, wherein the second set of prompts comprises one or more progress bar displayed within the second display area, each changing in length at a specified rate, wherein the user is prompted to perform the second type in input in response to a length of a progress bar of the one or more progress bars reaching below a threshold value.

9. The computer implemented method of claim 8, wherein the second type of input comprises an activation of a button by the user.

10. The computer implemented method of claim 9, wherein the second performance metric is based upon at least a number of times the user was able to, during the time period, successfully activate the button when the length of the progress bar reaches below the threshold value.

11. The computer implemented method of claim 1, wherein the interactive game interface is further configured to:
within a third display area separate from the first and second display areas, present to the user a third set of prompts over the time period prompting the user to perform a third type of input.

12. The computer implemented method of claim 1, wherein the additional performance metric is inversely proportional to the level of disparity between the first performance metric and the second performance metric.

13. The computer-implemented method of claim 1, wherein at least one of the first set of prompts and the second set of prompts comprises one or more audio prompts.

14. The computer-implemented method of claim 1, wherein the interactive game interface is further configured to, within the first display area, present to the user a third set of prompts over the time period prompting the user to perform a third type of input, and wherein the first performance metric is further based upon a third set of inputs received from the user relative to the displayed third set of prompts.

15. The computer-implemented method of claim 1, further comprising:
receiving, via a second user device, a communication indicative of an input by a second user at the second user device in response to a prompt provided to the second user at a second interactive game interface;
wherein the interactive game interface is further configured to:
based upon the received communication, present to the user an indication of the received communication;
present to the user an additional prompt based upon the prompt provided to the second user at the second interactive game interface;
determine a performance metric for the second user, based upon a received input from the user in response to the additional prompt presented at the interactive game interface.

16. The computer-implemented method of claim 15, wherein the indication of the received communication comprises an audio indication.
